(19) United States
(12) Patent Application Publication
(10) Pub. No.: US 2017/0287499 A1
(43) Pub. Date: Oct. 5, 2017

(54) METHOD AND APPARATUS FOR ENHANCING SOUND SOURCES

(71) Applicant: THOMSON LICENSING, Issy les Moulineaux (FR)

(72) Inventors: Quang Khanh Ngoc DUONG, RENNES (FR); Pierre BERTHET, Noyal Chatillon sur Seiche (FR); Eric ZABRE, Chays (FR); Michel KERDRANVAT, Chantepie (FR)

(21) Appl. No.: 15/508,925

(22) PCT Filed: Aug. 25, 2015
(86) PCT No.: PCT/EP2015/069417

§ 371 Date: Mar. 5, 2017

(30) Foreign Application Priority Data
Sep. 5, 2014 (EP) 14306365.9
Dec. 4, 2014 (EP) 14306947.4

(51) Int. Cl. G10L 21/02; H04R 3/00; G10L 21/0208; H04R 1/40

(52) U.S. Cl. CPC G10L 21/0205; H04R 1/406; H04R 3/005; G10L 21/0208; G10L 2021/02166

(57) ABSTRACT

A recording is usually a mixture of signals from several sound sources. The directions of the dominant sources in the recording may be known or determined using a source localization algorithm. To isolate or focus on a target source, multiple beamformers may be used. In one embodiment, each beamformer points to a direction of a dominant source and the outputs from the beamformers are processed to focus on the target source. Depending on whether the beamformer pointing to the target source has an output that is larger than the outputs of other beamformers, a reference signal or a scaled output of the beamformer pointing to the target source can be used to determine the signal corresponding to the target source. The scaling factor may depend on a ratio of the output of the beamformer pointing to the target source and the maximum value of the outputs of the other beamformers.

### TECHNICAL FIELD

This invention relates to a method and an apparatus for enhancing sound sources, and more particularly, to a method and an apparatus for enhancing a sound source from a noisy recording.

### BACKGROUND

A recording is usually a mixture of several sound sources (for example, target speech or music, environmental noise, and interference from other speeches) that prevents a listener from understanding and focusing on the sound source of interest. The ability to isolate and focus on the sound source of interest from a noisy recording is desirable in applications such as, but not limited to, audio/video conferencing, voice recognition, hearing aid, and audio zoom.

### SUMMARY

According to an embodiment of the present principles, a method for processing an audio signal is presented, the audio signal being a mixture of at least a first signal from a first audio source and a second signal from a second audio source, comprising: processing the audio signal to generate a first output using a first beamformer pointing to a first direction, the first direction corresponding to the first audio source; processing the audio signal to generate a second output using a second beamformer pointing to a second direction, the second direction corresponding to the second audio source; and processing the first output and the second output to generate an enhanced first signal as described below. According to another embodiment of the present principles, an apparatus for performing these steps is also presented.

According to an embodiment of the present principles, a method for processing an audio signal is presented, the audio signal being a mixture of at least a first signal from a first audio source and a second signal from a second audio source, comprising: processing the audio signal to generate a first output using a first beamformer pointing to a first direction, the first direction corresponding to the first audio source; processing the audio signal to generate a second output using a second beamformer pointing to a second direction, the second direction corresponding to the second audio source; determining the first output to be dominant between the first output and the second output; and processing the first output and the second output to generate an enhanced first signal, wherein the processing to generate the enhanced first signal is based on a reference signal if the first output is determined to be dominant, and wherein the processing to generate the enhanced first signal is based on the first output weighted by a first factor if the first output is not determined to be dominant as described below. According to another embodiment of the present principles, an apparatus for performing these steps is also presented.

According to an embodiment of the present principles, a computer readable storage medium having stored thereon instructions for processing an audio signal, the audio signal being a mixture of at least a first signal from a first audio source and a second signal from a second audio source according to the methods described above is presented.

### BRIEF DESCRIPTION OF THE DRAWINGS

FIG. 1 illustrates an exemplary audio system that enhances a target sound source.

FIG. 2 illustrates an exemplary audio enhancement system, in accordance with an embodiment of the present principles.

FIG. 3 illustrates an exemplary method for performing audio enhancement, in accordance with an embodiment of the present principles.

FIG. 4 illustrates an exemplary audio enhancement system, in accordance with an embodiment of the present principles.

FIG. 5 illustrates an exemplary audio zoom system with three beamformers, in accordance with an embodiment of the present principles.

FIG. 6 illustrates an exemplary audio zoom system with five beamformers, in accordance with an embodiment of the present principles.

FIG. 7 depicts a block diagram of an exemplary system where an audio processor can be used, in accordance with an embodiment of the present principles.

### DETAILED DESCRIPTION

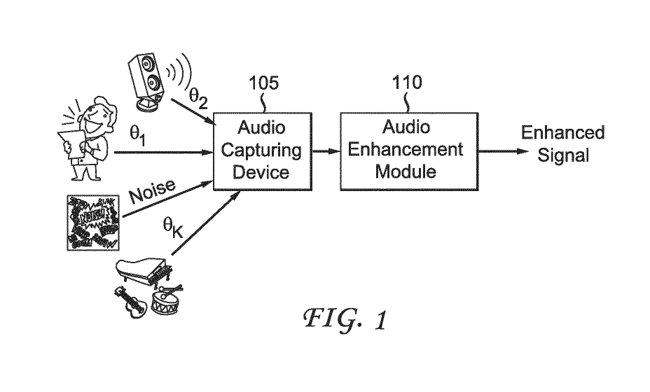

FIG. 1 illustrates an exemplary audio system that enhances a target sound source. An audio capturing device (105), for example, a mobile phone, obtains a noisy recording (for example, a mixture of a speech from a man at direction θ₁, a speaker playing music at direction θ₂, noise from the background, and instruments playing music at direction θₖ, wherein θ₁, θ₂, . . . or θₖ represents the spatial direction of a source with respect to the microphone array). Audio enhancement module 110, based on a user request, for example, a request to focus on the man's speech from a user interface, performs enhancement for the requested source and outputs the enhanced signal. Note that the audio enhancement module 110 can be located in a separate device from the audio capturing device 105, or it can also be incorporated as a module of the audio capturing device 105.

There exist approaches that can be used to enhance a target audio source from a noisy recording. For example, audio source separation has been known to be a powerful technique to separate multiple sound sources from their mixture. The separation technique still needs improvement in challenging cases, e.g., with high reverberation, or when the number of sources is unknown and exceeds the number of sensors. Also, the separation technique is currently not suitable for real-time applications with a limited processing power.

Another approach known as beamforming uses a spatial beam pointing to the direction of a target source in order to enhance the target source. Beamforming is often used with post-filtering techniques for further diffuse noise suppression. One advantage of beamforming is that the computation requirement is not expensive with a small number of microphones and therefore is suitable for real-time applications. However, when the number of microphones is small (e.g., 2 or 3 microphones as for current mobile devices) the generated beam pattern is not narrow enough so as to suppress the background noise and interference from unwanted sources. Some existing works also proposed to couple beamforming with spectral substraction for meeting recognition and speech enhancement in mobile devices. In these works, a target source direction is usually assumed to be known and the considered null-beamforming may not be robust to the reverberation effect. Moreover spectral substraction step may also add artifacts to the output signal.

The present principles are directed to a method and system to enhance a sound source from a noisy recording. According to a novel aspect of the present principles, our proposed method uses several signal processing techniques, for example, but not limited to, source localization, beamforming, and post-processing based on the outputs of several beamformers pointing to different source directions in space, which may efficiently enhance any target sound source. In general, the enhancement would improve the quality of the signal from the target sound source. Our proposed method has a light computation load and can be used in real-time applications such as, but not limited to, audio conferencing and audio zoom even in mobile devices with a limited processing power. According to another novel aspect of the present principles, progressive audio zoom (0%-100%) can be performed based on the enhanced sound source.

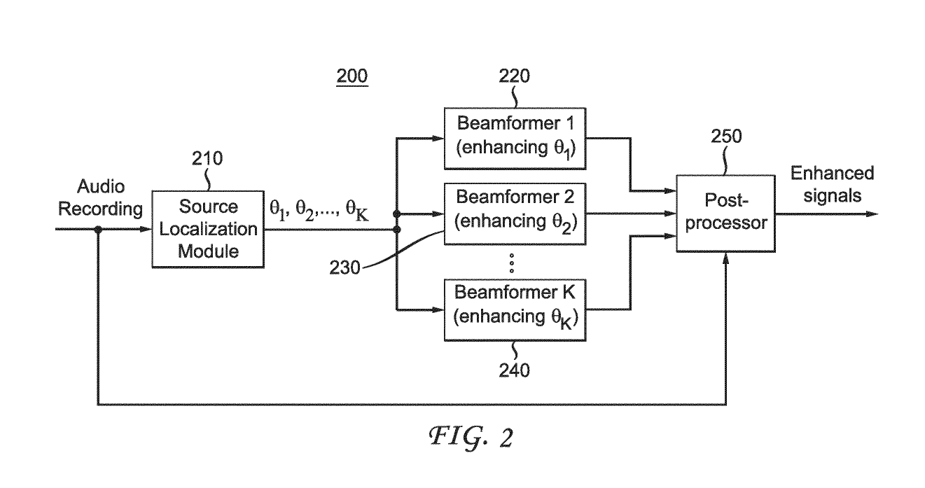

FIG. 2 illustrates an exemplary audio enhancement system 200 according to an embodiment of the present principles. System 200 accepts an audio recording as input and provides enhanced signals as output. To perform audio enhancement, system 200 employs several signal processing modules, including source localization module 210 (optional), multiple beamformers (220, 230, 240), and a post-processor 250. In the following, we describe each signal processing block in further detail.

Source Localization

Given an audio recording, a source localization algorithm, for example, the generalized cross correlation with phase transform (GCC-PHAT), can be used to estimate the directions of dominant sources (also known as Direction-of-Arrival DoA) when they are unknown. As a result, DoAs of different sources θ₁, θ₂, . . . , θ_{K} can be determined, where K is the total number of dominant sources. When the DoAs are known in advance, for example, when we point a smartphone to a certain direction to capture video, we know that the source of interest is right in front of the microphone array (θ₁=90 degree), and we do not need to perform the source localization function to detect DoAs, or we only perform source localization to detect DoAs of dominant interference sources.

Beamforming

Given the DoAs of dominant sound sources, beamforming can be employed as a powerful technique to enhance a specific sound direction in space, while suppressing signals from other directions. In one embodiment, we use several beamformers pointing to different directions of dominant sources to enhance the corresponding sound sources. Let us denote by x(n,f) the short time Fourier transform (STFT) coefficients (signal in a time-frequency domain) of the observed time domain mixture signal x(t), where n is the time frame index and f is the frequency bin index. The output of the j-th beamformer (enhancing sound source in direction θⱼ) can be computed as

sⱼ(n,f)=wⱼ^{H}(n,f)x(n,f) (1)

where wⱼ(n,f) is a weighting vector derived from the steering vector pointing to the target direction of beamformer j, and H denotes vector conjugate transpose. wⱼ(n,f) may be computed in different ways for different types of beamformers, for example, using Minimum Variance Distortionless Response (MVDR), Robust MVDR, Delay and Sum (DS) and generalized sidelobe canceller (GSC).

Post-processing

The output of a beamformer is usually not good enough in separating interference and applying post-processing directly to this output may lead to strong signal distortion. One reason is that the enhanced source usually contains a large amount of musical noise (artifact) due to (1) the nonlinear signal processing in beamforming, and (2) the error in estimating the directions of dominant sources, which can lead to more signal distortion at high frequencies because a DoA error can cause a large phase difference. Therefore, we propose to apply post-processing to the outputs of several beamformers. In one embodiment, the post-processing can be based on a reference signal x_{I} and the outputs of the beamformers, wherein the reference signal can be one of the input microphones, for example, a microphone facing the target source in a smartphone, a microphone next to a camera in a smartphone, or a microphone close to the mouth in a bluetooth headphone. A reference signal can also be a a more complex signal generated from multiple microphone signals, for example, a linear combination of multiple microphone signals. In addition, time-frequency masking (and optionally spectral substraction) can be used to produce the enhanced signal.

In one embodiment, the enhanced signal is generated as, e.g., for source j:

$${\hat{s}}_{j} ( n , f ) = \{ \begin{matrix}{x}_{I} ( n , f ) & \begin{matrix}if \vert {s}_{j} ( n , f ) \vert > α * \\ max \{ \vert {s}_{i} ( n , f ) \vert , ∀ i \neq j \}\end{matrix} \\ β * {s}_{j} ( n , f ) & otherwise\end{matrix} \qquad ( 2 )$$

where x_{I}(n,f) is STFT coefficients of the reference signal, α and β are tuning constants, in one example, α=1, 1.2, or 1.5, β=0.05-0.3. The specific values of α and β may be adapted based on the applications. One underlying assumption in Eq. (2) is that the sound sources are almost non-overlapped in time-frequency domain, thus if source j is dominant in time-frequency point (n,f) (i.e., the output of beamformer j is larger than the outputs of all other beamformers), a reference signal can be considered as a good approximate of the target source. Consequently, we can set the enhanced signal to be the reference signal x_{I}(n,f) to reduce the distortion (artifact) caused by beamforming as contained in sⱼ(n,f). Otherwise, we assume the signal is either noise or a mix of noise and target source, and we may choose to suppress it by setting ŝⱼ(n,f) to a small value β*sⱼ(n,f).

In another embodiment, the post-processing can also use spectral substraction, a noise suppression method. Mathematically, it can be described as:

$${\hat{s}}_{j} ( n , f ) = \{ \begin{matrix}\sqrt{{\vert {x}_{I} ( n , f ) \vert}^{2} - {σ}_{j}^{2} ( f )} * & \begin{matrix}phase ( {x}_{I} ( n , f ) ) if \\ \vert {s}_{j} ( n , f ) \vert > α * \\ max \{ \vert {s}_{i} ( n , f ) \vert , ∀ i \neq j \}\end{matrix} \\ β * {s}_{j} ( s , f ) & \begin{matrix}otherwise , and update \\ noise level {σ}_{j}^{2} ( f )\end{matrix}\end{matrix} \qquad ( 3 )$$

where phase (x_{I}(n,f)) denotes phase information of the signal x_{I}(n,f), and σⱼ²(f) is frequency-dependent spectral power of noise affecting source j that can be continuously updated. In one embodiment, if a frame is detected as a noisy frame, then the noise level can be set to the signal level of that frame, or it can be smoothly updated by a forgetting factor taking into account the previous noise values.

In another embodiment, post-processing performs “cleaning” on the outputs of the beamformers, in order to obtain more robust beamformers. This can be done adaptively with a filter as follows:

ŝⱼ(n,f)=βⱼ(n,f)*sⱼ(n,f) (4)

where the βⱼ factor depends on the quantity

$$\frac{\vert {s}_{j} ( n , f ) \vert}{max \{ \vert {s}_{i} ( n , f ) \vert , ∀ i \neq j \}}$$

that can be seen as a time-frequency Signal-to-Interferer Ratio. For example, we can set β as below for making a “soft” post-processing “cleaning”:

$${β}_{j} ( n , f ) = \frac{1}{ɛ + \frac{max \{ \vert {s}_{i} ( n , f ) \vert , ∀ i \neq j \}}{\vert {s}_{j} ( n , f ) \vert}} \qquad ( 5 )$$

where ε is a small constant, for example, ε=1. Thus, when ↑sⱼ(n,f)| is much higher than every other |sᵢ(n,f)|, the cleaned output is ŝⱼ(n,f)≈sⱼ(n,f), and when sⱼ(n,f) is much smaller than another sᵢ(n,f), the cleaned output is ŝⱼ(n,f)≈0.

We can also set β as below for making a “hard” (binary) cleaning:

$${β}_{j} ( n , f ) = \{ \begin{matrix}1 & if \vert {s}_{j} ( n , f ) \vert > max \{ \vert {s}_{i} ( n , f ) \vert , ∀ i \neq j \} \\ 0 & otherwise\end{matrix} \qquad ( 6 )$$

βⱼ can also be set in an intermediate (i.e., between “soft” cleaning and “hard” cleaning) way by adjusting its values according to the level differences between |sⱼ(n,f)| and |sᵢ(n,f)|, i≠j.

These techniques described above (“soft”/“hard”/intermediate cleaning) can also be extended to the filtering of x_{I}(n,f) instead of sⱼ(n,f):

ŝⱼ(n,f)=βⱼ(n,f)*x_{I}(n,f). (7)

Note that in this case the βⱼ factor is still computed with the beamformers' outputs sⱼ(n,f) (instead of the original microphone signals), for taking advantage of beamforming.

For the techniques described above, we can also add a memory effect in order to avoid punctual false detections or glitches in the enhanced signals. For example, we may average the quantities implied in the decision of the post-processing, e.g., replacing:

|sⱼ(n,f)|>α*max{|sᵢ(n,f)|,∀ i≠j}

with the following sum:

$$\frac{1}{M} {\sum }_{m = 0}^{M - 1} \vert {s}_{j} ( n - m , f ) \vert > α * max \{ \vert \frac{1}{M} {\sum }_{m = 0}^{M - 1} \vert {s}_{i} ( n - m , f ) \vert \vert , ∀ i \neq j \}$$

where M is the number of frames taken into account for decision.

In addition, after signal enhancement as described above, other post-filtering techniques can be used to further suppress the diffuse background noise.

In the following, for ease of notation, we refer to the methods as described in Eqs. (2), (4) and (7) as bin separation, and the method as in Eq. (3) as spectral subtraction.

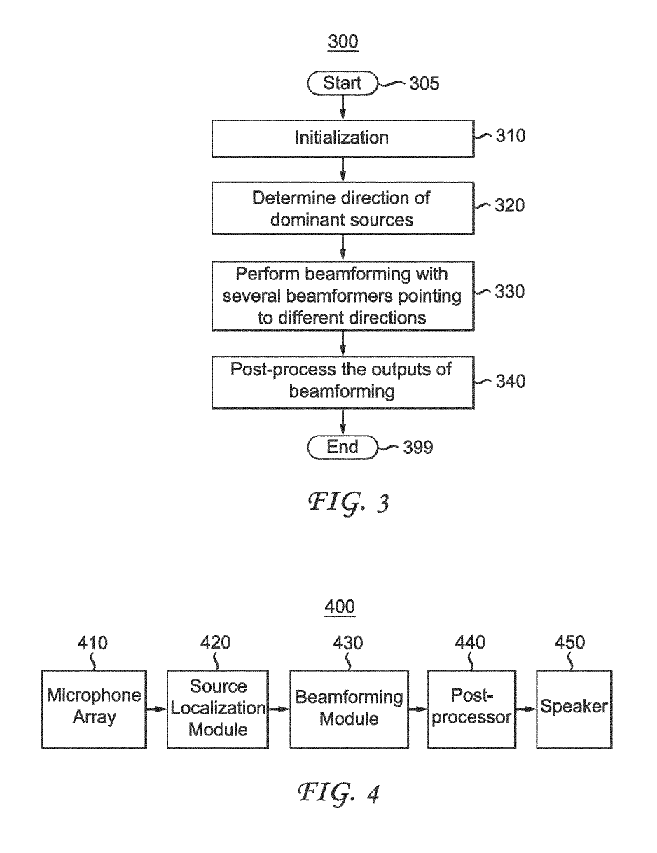

FIG. 3 illustrates an exemplary method 300 for performing audio enhancement according to an embodiment of the present principles. Method 300 starts at step 305. At step 310, it performs initialization, for example, determines whether it is necessary to use source localization algorithm to determine the directions of dominant sources. If yes, then it chooses an algorithm for source localization and sets up parameters thereof. It may also determine which beamforming algorithm to use or the number of beamformers, for example, based on user configurations.

At step 320, source localization is used to determine the directions of dominant sources. Note that if directions of dominant sources are known, step 320 can be skipped. At step 330, it uses multiple beamformers, each beamformer pointing to a different direction to enhance the corresponding sound source. The direction for each beamformer may be determined from source localization. If the direction of the target source is known, we may also sample the directions in the 360° field. For example, if the direction of the target source is known to be 90°, we can use 90°, 0°, and 180° to sample the 360° field. Different methods, for example, but not limited to, Minimum Variance Distortionless Response (MVDR), Robust MVDR, Delay and Sum (DS), and generalized sidelobe canceller (GSC) can be used for beamforming. At step 340, it performs post-processing on the outputs of the beamformers. The post-processing may be based on the algorithms as described in Eqs. (2)-(7), and can also be performed in conjunction with spectral subtraction and/or other post-filtering techniques.

FIG. 4 depicts a block diagram of an exemplary system 400 wherein audio enhancement can be used according to an embodiment of the present principles. Microphone array 410 records a noisy recording that needs to be processed. The microphone may record audio from one or more speakers or devices. The noisy recording may also be pre-recorded and stored in a storage medium. Source localization module 420 is optional. When source localization module 420 is used, it can be used to determine the directions of dominant sources. Beamforming module 430 applies multiple beamformings pointing to different directions. Based on the outputs of the beamformers, post-processor 440 performs post-processing, for example, using one of the methods described in Eqs. (2)-(7). After post-processing, the enhanced sound source can be played by speaker 450. The output sound may also be stored in a storage medium or transmitted to a receiver through a communication channel.

Different modules shown in FIG. 4 may be implemented in one device, or distributed over several devices. For example, all modules may be included in, but not limited to, a tablet or mobile phone. In another example, source localization module 420, beamforming module 430 and post-processor 440 may be located separately from other modules, in a computer or in the cloud. In yet another embodiment, microphone array 410 or speaker 450 can be a standalone module.

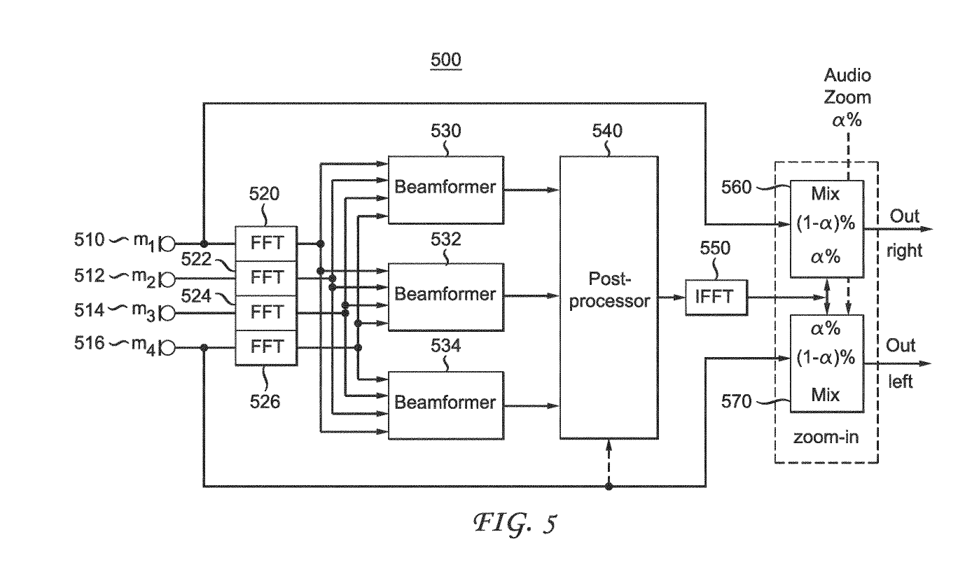

FIG. 5 illustrates an exemplary audio zoom system 500 wherein the present principles can be used. In an audio zoom application, a user may be interested in only one source direction in space. For example, when the user points a mobile device to a specific direction, the specific direction the mobile device points to can be assumed to be the DoA of the target source. In the example of audio-video capture, the DoA direction can be assumed to be the direction toward which the camera faces. Interferers are then the out-of-scope sources (on the side of and behind the audio capturing device). Thus, in the audio zoom application, since the DoA direction can usually be inferred from the audio capturing device, source localization can be optional.

In one embodiment, a main beamformer is set to point to target direction θ while (possibly) several other beamformers are pointing to other non-target directions (e.g., θ-90°, θ45°, 0+45°, θ+90°) to capture more noise and interference for the user during post-processing.

Audio system 500 uses four microphones m₁-m₄ (510, 512, 514, 516). The signal from each microphone is transformed from the time domain into the time-frequency domain, for example, using FFT modules (520, 522, 524, 526). Beamformers 530, 532 and 534 perform beamforming based on the time-frequency signals. In one example, beamformers 530, 532 and 534 may point to directions 0°, 90°, 180°, respectively, to sample the sound field) (360°). Post-processor 540 performs post-processing based on the outputs of beamformers 530, 532 and 534, for example, using one of the methods described in Eqs. (2)-(7). When a reference signal is used for post-processor, post-processor 540 may use the signal from a microphone (for example, m₄) as the reference signal.

The output of post-processor 540 is transformed from the time-frequency domain back to the time domain, for example, using IFFT module 550. Based on an audio zoom factor α (with a value from 0 to 1), for example, provided by a user request through a user interface, mixers 560 and 570 generate the right output and the left output, respectively.

The output of the audio zoom is a linear mix of left and right microphones signals (m₁ and m₄) with the enhanced output from the IFFT module 550 according to the zoom factor a. The output is stereo with Out left and Out right. In order to keep a stereo effect the maximum value of a should be lower than 1 (for instance 0.9).

A frequency and spectral subtraction can be used in the post-processor in addition to the methods described in Eqs. (2)-(7). A psycho-acoustic frequency mask can be computed from the bin separation output. The principle is that a frequency bin having a level outside of the psycho-acoustical mask is not used to generate the output of the spectral subtraction.

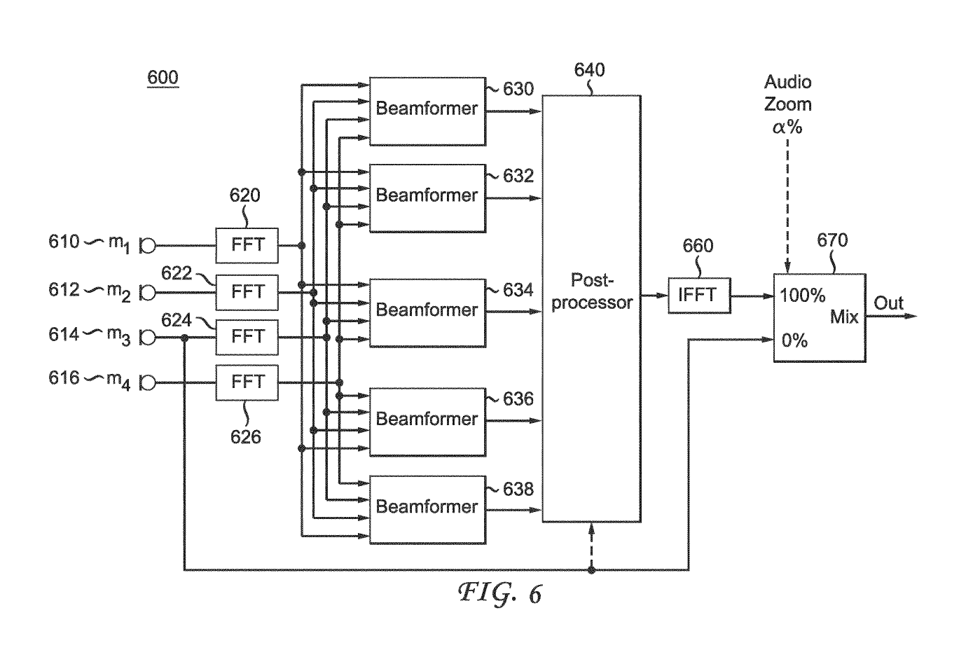

FIG. 6 illustrates another exemplary audio zoom system 600 wherein the present principles can be used. In system 600, 5 beamformers are used instead of 3. In particular, the beamformers point to directions 0°, 45°, 90°, 135°, and 180° respectively.

Audio system 600 also uses four microphones m₁-m₄ (610, 612, 614, 616). The signal from each microphone is transformed from the time domain into the time-frequency domain, for example, using FFT modules (620, 622, 624, 626). Beamformers 630, 632, 634, 636, and 638 perform beamforming based on the time-frequency signals, and they point to directions 0°, 45°, 90°, 135°, and 180° , respectively. Post-processor 640 performs post-processing based on the outputs of beamformers 630, 632, 634, 636, and 638, for example, using one of the methods described in Eqs. (2)-(7). When a reference signal is used for post-processor, post-processor 540 may use the signal from a microphone (for example, m₃) as the reference signal. The output of post-processor 640 is transformed from the time-frequency domain back to the time domain, for example, using IFFT module 660. Based on an audio zoom factor, mixer 670 generates an output.

The subjective quality of one or the other post-processing technique varies with the number of microphones. In one embodiment, with two microphones bin separation only is preferred while with 4 microphones bin separation and spectral subtraction is preferred.

The present principles can be applied when there are multiple microphones. In systems 500 and 600, we assume the signals are from four microphones. When there are only two microphones, a mean value (m₁+m₂)/2 can be used as m₃ in post-processing using spectral subtraction if needed. Note the reference signal here can be from one microphone closer to the target source or the mean value of the microphone signals. For example, when there are three microphones, the reference signal for spectral subtraction can be either (m₁+m2+m3)/3, or directly m₃ if m₃ faces the source of interest.

In general, the present embodiments use the outputs of beamforming in several directions to enhance the beamforming in the target direction. By performing beamforming in several direction, we sample the sound field (360°) in multiple directions and can then post-process the outputs of the beamformers to “clean” the signal from the target direction.

Audio zoom systems, for example, system 500 or 600, can also be used for audio conferencing, wherein speeches of speakers from different locations can be enhanced and the use of multiple beamformers pointing to multiple directions is well applicable. In audio conferencing, a recording device's position is often fixed (e.g., placed on a table with a fixed position), while the different speakers are located at arbitrary positions. Source localization and tracking (e.g., for tracking moving speaker) can be used to learn the positions of the sources before steering the beamformers to these sources. To improve the accuracy of source localization and beamforming, dereverberation technique can be used to pre-process an input mixture signal so as to reduce the reverberation effect.

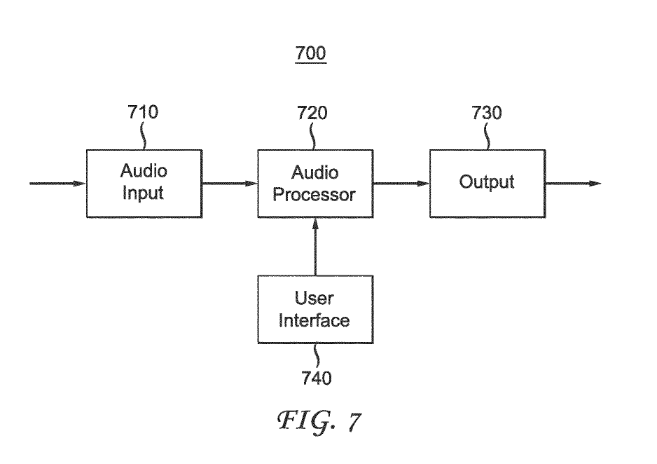

FIG. 7 illustrates an audio system 700 wherein the present principles can be used. The input to system 700 can be an audio stream (e.g., an mp3 file) or audio-visual stream (e.g., an mp4 file), or signals from different inputs. The input can also be from a storage device or be received from a communication channel. If the audio signal is compressed, it is decoded before being enhanced. Audio processor 720 performs audio enhancement, for example, using method 300, or system 500 or 600. A request for audio zoom may be separate from or included in a request for video zoom.

Based on a user request from a user interface 740, system 700 may receive an audio zoom factor, which can control the mix proportion of microphone signals and the enhanced signal. In one embodiment, the audio zoom factor can also be used to tune the weighting value of βⱼ so as to control the amount of noise remaining after post-processing. Subsequently, the audio processor 720 may mix the enhanced audio signal and microphone signals to generate the output. Output module 730 may play the audio, store the audio or transmit the audio to a receiver.

The implementations described herein may be implemented in, for example, a method or a process, an apparatus, a software program, a data stream, or a signal. Even if only discussed in the context of a single form of implementation (for example, discussed only as a method), the implementation of features discussed may also be implemented in other forms (for example, an apparatus or program). An apparatus may be implemented in, for example, appropriate hardware, software, and firmware. The methods may be implemented in, for example, an apparatus such as, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation” of the present principles, as well as other variations thereof, mean that a particular feature, structure, characteristic, and so forth described in connection with the embodiment is included in at least one embodiment of the present principles. Thus, the appearances of the phrase “in one embodiment” or “in an embodiment” or “in one implementation” or “in an implementation”, as well any other variations, appearing in various places throughout the specification are not necessarily all referring to the same embodiment.

Additionally, this application or its claims may refer to “determining” various pieces of information. Determining the information may include one or more of, for example, estimating the information, calculating the information, predicting the information, or retrieving the information from memory.

Further, this application or its claims may refer to “accessing” various pieces of information. Accessing the information may include one or more of, for example, receiving the information, retrieving the information (for example, from memory), storing the information, processing the information, transmitting the information, moving the information, copying the information, erasing the information, calculating the information, determining the information, predicting the information, or estimating the information.

Additionally, this application or its claims may refer to “receiving” various pieces of information. Receiving is, as with “accessing”, intended to be a broad term. Receiving the information may include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

As will be evident to one of skill in the art, implementations may produce a variety of signals formatted to carry information that may be, for example, stored or transmitted. The information may include, for example, instructions for performing a method, or data produced by one of the described implementations. For example, a signal may be formatted to carry the bitstream of a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

1-15. (canceled)

16. A method, to be performed in an audio processing apparatus, for processing an audio signal, the audio signal being a mixture of input signals from at least two audio inputs, the method comprising:
processing the audio signal to generate at least two outputs, each output being generated by using a beamformer pointing to a different spatial direction;
determining at least one dominant output between said generated outputs;
processing said outputs to generate:
a first enhanced signal, said first enhanced signal being generated based on a reference signal being a linear combination of said input signals;
at least one second enhanced signal, said at least one second enhanced signal being generated based on one of said outputs other than said dominant output.

17. The method of claim 16, comprising performing source localization on the audio signal.

18. The method of claim 17, wherein said spatial direction takes into account said source localization.

19. The method of claim 16, wherein said second enhanced signal is generated based on said at least one output other than said dominant output, weighted by a first factor.

20. The method of claim 16, wherein the dominant output is assumed to be the output of a beamformer having a spatial direction being a direction faced by a camera of said audio processing apparatus.

21. The method of claim 16, comprising determining a ratio between said outputs, and wherein said first and second enhanced signals are generated in response to the ratio.

22. The method of claim 16, further comprising combining said first and second enhanced signals to provide an output audio.

23. An apparatus for processing an audio signal, the audio signal being a mixture of at least two audio inputs, said apparatus comprising at least two beamformers and at least one processor configured to:
process the audio signal to generate at least two outputs, each output being generated by using one of said beamformers pointing to a different spatial direction;
determine at least one dominant output between said generated outputs;
process said outputs to generate:
a first enhanced signal, said first enhanced signal being generated based on a reference signal being a linear combination of said input signals;
at least one second enhanced signal, said at least one second enhanced signal being generated based on at least one of said outputs other than said not dominant output.

24. The apparatus of claim 23, comprising a source localization module configured to perform source localization on the audio signal.

25. The apparatus of claim 24, wherein said spatial direction takes into account said source localization.

26. The apparatus of claim 23, wherein the processor is configured to generate said second enhanced signal based on said at least one output other than said dominant output, weighted by a first factor.

27. The apparatus of claim 23, wherein the dominant output is assumed to be the output of a beamformer having a spatial direction being a direction faced by a camera of said apparatus.

28. The apparatus of claim 23, comprising an audio capturing device comprising said audio inputs.

29. The apparatus of claim 23, wherein the processor is configured to generate combine said first and second enhanced signals to provide an output audio to an output module of said apparatus.

30. A computer readable storage medium having stored thereon instructions for processing an audio signal, the audio signal being a mixture of input signals from at least two audio inputs, the processing comprising:
processing the audio signal to generate at least two outputs, each output being generated by using a beamformer pointing to a different spatial direction;
determining at least one dominant output between said generated outputs;
processing said outputs to generate:
a first enhanced signal, said first enhanced signal being generated based on a reference signal being a linear combination of said input signals;
at least one second enhanced signal, said at least one second enhanced signal being generated based on at least one of said outputs other than said dominant output.
